(19) United States
(12) Patent Application Publication
(10) Pub. No.: US 2013/0207632 A1
(43) Pub. Date: Aug. 15, 2013

(54) SYSTEM AND METHOD FOR IMPROVED LINE TRANSIENT RESPONSE IN CURRENT MODE BOOST CONVERTERS

(71) Applicants: Gurjit Singh THANDI, San Jose, CA (US); Harry Hui, San Francisco, CA (US)

(72) Inventors: Gurjit Singh THANDI, San Jose, CA (US); Harry Hui, San Francisco, CA (US)

(21) Appl. No.: 13/372,254

(22) Filed: Feb. 13, 2012

(51) Int. Cl. G05F 1/10

(52) U.S. Cl. 323/288

(57) ABSTRACT

An improved DC-DC power converter employs a feed-forward circuit to improve the response of the output voltage to transient signals on the input voltage. A portion of the input voltage generated by the feed-forward circuit is combined with either the sense voltage or the set point reference to offset one of the voltages applied to the PWM circuit comparator. The feed-forward circuit essentially bypasses the PWM feedback loop to quickly pre-compensate for the input transient and allow the output voltage to settle rapidly at a new operating point. The feed-forward circuit can be implemented with a resistive voltage divider network connected to the input voltage.

### BACKGROUND OF THE INVENTION

1. Field of the Invention

The present invention relates to DC-DC power converters, and more particularly, to boost converters employing feed-forward voltage sensing for improved line transient response.

2. Description of Related Art

DC-DC power converters are known in the art and operate to deliver a regulated voltage from an input power source. A boost converter is a switching-mode DC-DC converter that produces an output voltage greater than the input voltage. FIGS. 1a and 1b illustrate the basic operation of a boost converter, showing its operation in the on state and off state, respectively. Input voltage 102 Vin is boosted to a higher output voltage delivered to the load 112. An inductor 104 and a capacitor 110 operate to provide energy storage. When the primary switch 108 is closed (on), current 114 increases through the inductor 104. When the primary switch 108 is opened (off), the inductor current 120 flows through the capacitor 110 and load 112 via flyback diode 106. As a result, the energy stored in the inductor 104 during the on state is transferred to the capacitor 110 during the off state. The voltage delivered to the load depends on the duty cycle of the primary switch according to the following relationship:

(Vout/Vin)=1/(1-D),

where Vout is the output voltage delivered to the load, Vin is the input voltage, and D is the duty cycle, ranging from 0 to 1. Thus, the output voltage increases as the duty cycle increases.

FIG. 2 is a block diagram of a power converter control circuit typical of the prior art that does not include the feed-forward component of the present invention. The boost switch 202 is driven by a pulse width modulation (PWM) circuit including an oscillator/ramp generator 204, an S-R latch 206, and a PWM comparator 208, driven by supporting circuitry. Current sense resistor 212 samples the boost switch current, which is amplified by the current sense amplifier 210. This representation of the boost switch current is then added to the PWM ramp at summing junction 214. This ramp is then applied to the PWM comparator 208 and the output of the summing junction 220 is compared with a reference voltage/operating set point 218 developed by the exemplary circuitry shown at 216. PWM comparator 208 thus adjusts the duty cycle of the boost switch in order to keep the boost switch current (and thus output voltage of the converter) within the specified range.

FIG. 3 depicts an exemplary waveform illustrating the behavior of the DC-DC converter during a steady state condition. The waveform 304 represents the behavior of the output of the summing junction 220 in FIG. 2. Increasing current flowing through the current sense resistor causes the summing junction output voltage to increase. When the waveform 304 reaches the value of the waveform 302 at intersection point 306, the PWM circuitry causes the Boost Switch to open. With current no longer flowing in the resistor, the voltage waveform 304 drops to zero. The waveform 302 represents the behavior of the operating set point voltage signal 218 in FIG. 2. While a constant voltage could be employed, the gradual decreasing slope shown in waveform 302 during each PWM cycle represents a technique known as current mode compensation. This negative slope prevents feedback loop open loop instability and prevents a gradual buildup of error known as “sub-cycle oscillation.”

FIG. 4 depicts a waveform for the behavior of a system typical of the prior art illustrating the behavior of the DC-DC converter when the converter input voltage is suddenly stepped upward. When the input voltage, Vin (422), suddenly rises the set point voltage can not immediately drop to adjust the duty cycle in response to the input voltage change. Referring back to the input/output relationship equation, (Vout/Vin)=1/(1-D), the output voltage also rises in proportion to the input. In order to reach the desired output voltage the set point voltage gradually decays until the PWM eventually reaches a steady state operation point with the desired output voltage. During this entire transition time, the output voltage is not provided at the desired level.

FIGS. 5a and 5b compare the input voltage and current relationship in buck mode converters with input voltage and current relationship in boost mode converters. In the current-mode buck controller (FIG. 5a), current in the inductor 520 is delivered to the load 112 continuously. In the first part of the phase current flows through switch circuit 506 and in the second part of the phase current flows through switch circuit 508. The slope of the inductor current changes when Vin 402 changes, but the peak current remains roughly the same. Because the peak current does not change in the buck converter, the operating set point 540 also does not need to change, and the transient response is relatively stable.

In the current-mode boost controller (FIG. 5b), current is only supplied to the load 112 when the switch circuit 108 is open or in the off state. When Vin changes (524), the peak inductor current must change to maintain the relationship Vin1*IL1=Vin2*IL2, where Vin1 (526) and Vin2 (528) represent the two input voltages, and IL1 (532) and IL2 (534) represent the average inductor current before and after the input voltage change. In the prior art, when Vin changes, the operating set point 542 must also decrease to a new operating set point value 544 to maintain voltage delivered to the load 112. Settling of the operating set point to a new level causes an undesirable transient response to the changing input voltage.

Because output voltage is related to input voltage, rapid transients on the input voltage can lead to large excursions in the output voltage of current-mode boost converters. These excursions can cause difficulties, such as falsely tripping over-voltage protection features or shorting LED protection circuits when a converter is used to drive a string of LEDs. Accordingly, it would be useful to improve the transient response of boost converters by helping to eliminate the need for changing the operating set point in order to minimize output voltage excursions.

### SUMMARY OF THE INVENTION

This invention is directed to boost-mode power converters. However, the system and method are equally applicable to other switching power converter applications and circuit topologies.

An embodiment of a boost-mode power converter in accordance with this invention comprises an input voltage source coupled with a boost switch. A Pulse Width Modulation (PWM) circuit controls the opening and closing of the boost switch. A current sense circuit measures the current through the boost switch and provides a sense voltage indicative of the boost switch current. A ramp generator creates a periodic ramp, which is added to the sense voltage at a summing junction. A feed-forward circuit combines a portion of the input voltage with the periodic ramp and the sense voltage at the summing junction to create a feedback ramp voltage. A comparison circuit compares the feedback ramp voltage with the voltage set point, and triggers the PWM circuit when the feedback ramp voltage exceeds the voltage set point. Because one of the inputs to the comparison circuit is combined with a portion of the input voltage, when the input voltage changes, a time at which the comparison circuit triggers the PWM circuit also changes.

An embodiment of a boost-mode power converter in accordance with this invention comprises an input voltage source coupled with a boost switch. A Pulse Width Modulation (PWM) circuit controls the opening and closing of the boost switch. A current sense circuit measures the current through the boost switch and provides a sense voltage indicative of the boost switch current. A ramp generator creates a periodic ramp, which is added to the sense voltage at a summing junction. The summing junction outputs a feedback ramp voltage. A feed-forward circuit combines a portion of the input voltage with a voltage set point, forming a comparison voltage. A comparison circuit compares the feedback ramp voltage with the comparison voltage, and triggers the PWM circuit when the feedback ramp voltage exceeds the voltage set point. Because one of the inputs to the comparison circuit is combined with a portion of the input voltage, when the input voltage changes, a time at which the comparison circuit triggers the PWM circuit also changes.

In another embodiment of a boost-mode power converter in accordance with this invention, the feed-forward circuit comprises a resistive divider network.

In another embodiment of a boost-mode power converter in accordance with this invention, the comparator circuit comprises a voltage comparator.

Another embodiment further comprises a current limit circuit configured to measure a current flowing through the boost switch to prevent the PWM circuit from switching the boost switch when the current flowing through the boost switch exceeds a present threshold level.

Another embodiment further comprises a slope compensation circuit configured to apply a voltage ramp to the voltage set point in order to improve system stability. This technique is sometimes referred to as current-mode compensation in the context of boost-mode power converters.

Another boost-mode power converter exhibiting improved transient response in accordance with this invention comprises an input voltage source coupled with a boost switch. A PWM circuit couple to the boost switch is configured to selectively open and close the boost switch. A current sense circuit is configured to provide a sense voltage indicative of a current flowing through the boost switch. A ramp generator is configured to generate a periodic ramp voltage. A feed-forward circuit comprising a resistive divider network operatively coupled to the input voltage source produces and output reflective of the input voltage. A summing junction configured to combine the sense voltage, the periodic voltage ramp, and the output of the feed-forward circuit creates a composite ramp voltage. A comparison circuit configured to compare a voltage set point and the composite ramp voltage triggers the PWM circuit when the composite ramp voltage exceeds the voltage set point.

In another embodiment of a boost-mode power converter exhibiting improved transient response in accordance with this invention, the comparison circuit comprises a voltage comparator.

Another embodiment further comprises a current limit circuit configured to measure a current flowing through the boost switch and to prevent the PWM circuit from switching the boost switch when the current flowing through the boost switch exceeds a preset threshold level.

Another embodiment further comprises a slope compensation circuit configured to apply a voltage ramp to the voltage set point in order to improve system stability.

An embodiment of a method for improving the input transient response of a boost-mode converter using a feed-forward circuit comprising an input voltage source, a boost switch coupled to the input voltage source, and a Pulse Width Modulation (PWM) circuit coupled to the boost switch and configured to selectively open and dose the boost switch includes the following steps. The method comprises generating a sense voltage indicative of a current flowing through the boost switch. The next step is to generate a period ramp voltage. A feed-forward voltage indicative of the input voltage is generated. The periodic voltage ramp, sense voltage, and feed-forward voltage are combined to form a feedback ramp voltage. The next step comprises comparing a voltage set point and the feedback ramp voltage and generating a trigger at a time when the feedback ramp voltage exceeds the comparison voltage. This trigger causes the PWM circuit timing to change at a time when the input voltage changes.

An embodiment of a method for improving the input transient response of a boost-mode converter using a feed-forward circuit comprising an input voltage source, a boost switch coupled to the input voltage source, and a Pulse Width Modulation (PWM) circuit coupled to the boost switch and configured to selectively open and close the boost switch includes the following steps. The method comprises generating a sense voltage indicative of a current flowing through the boost switch. The next step is to generate a period ramp voltage. A feed-forward voltage indicative of the input voltage is generated. The periodic voltage ramp and sense voltage, are combined to form a feedback ramp voltage. A voltage set point is combined with the feed-forward voltage to generate a comparison voltage. The next step comprises comparing the comparison voltage and the feedback ramp voltage and generating a trigger when the feedback ramp voltage exceeds the comparison voltage. This trigger causes the PWM circuit timing to change at a time when the input voltage changes.

In one embodiment of the method, the feed-forward voltage offsets the voltage set point. In another embodiment, the feed-forward voltage is combined with the feedback ramp voltage.

Another embodiment of the method further comprises the step of preventing the PWM circuit from switching the boost switch when a measured current flowing through the boost switch exceeds a preset threshold level.

Another embodiment of the method further comprises the step of applying a voltage ramp to the voltage set point in order to improve system stability.

Several embodiments of an apparatus and method for improving transient response in boost-mode converters are described above. Those of ordinary skill in the art will also recognize other modifications, embodiments, and applications of such a system for improving transient response, and these would also fall within the scope and spirit of the present invention.

### BRIEF DESCRIPTION OF THE DRAWINGS

FIGS. 1a and 1b depict a simplified block diagram of a boost converter typical of the prior art;

FIG. 2 depicts a schematic diagram of a boost converter operating in a current-control mode typical of the prior art;

FIG. 3 depicts a voltage waveform and timing diagram associated with a boost converter operating in a current-control mode typical of the prior art;

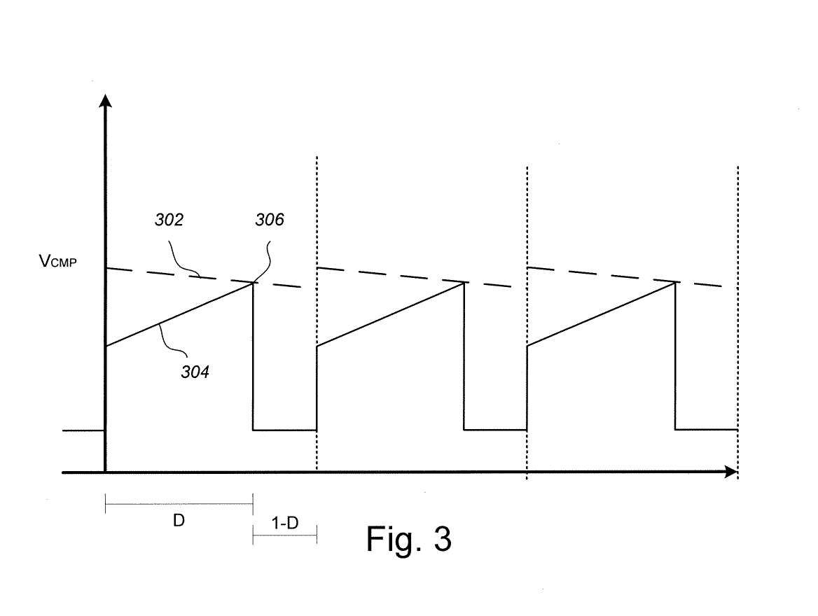

FIG. 4 depicts a voltage waveform and timing diagram associated with a boost converter operating in current-control mode typical of the prior art;

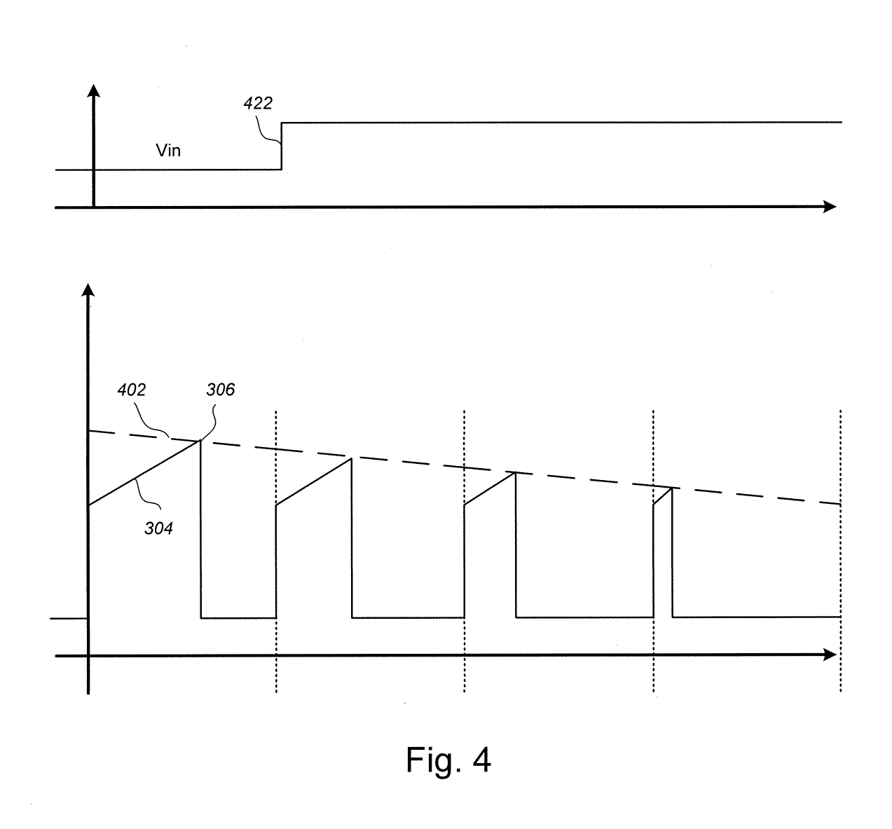

FIGS. 5a and 5b depict a comparison between buck converter and boost converter operation demonstrating the need for improved transient response in boost converts;

FIG. 6 depicts a schematic diagram of an improved boost converter operating in a current-control mode in accordance with the present invention;

FIG. 7 depicts a voltage waveform and timing diagram of an improved boost converter in accordance with the present invention;

FIG. 8 depicts an electrical simulation of a boost converter that does not include a feed-forward feature; and

FIG. 9 depicts an electrical simulation of a boost converter in accordance with an embodiment of the present invention that includes a feed-forward circuit for improving the transient response.

### DETAILED DESCRIPTION OF THE PREFERRED EMBODIMENT

An embodiment of the present invention includes an apparatus and method for improving the transient response of a boost converter by including a feed-forward component in the control loop.

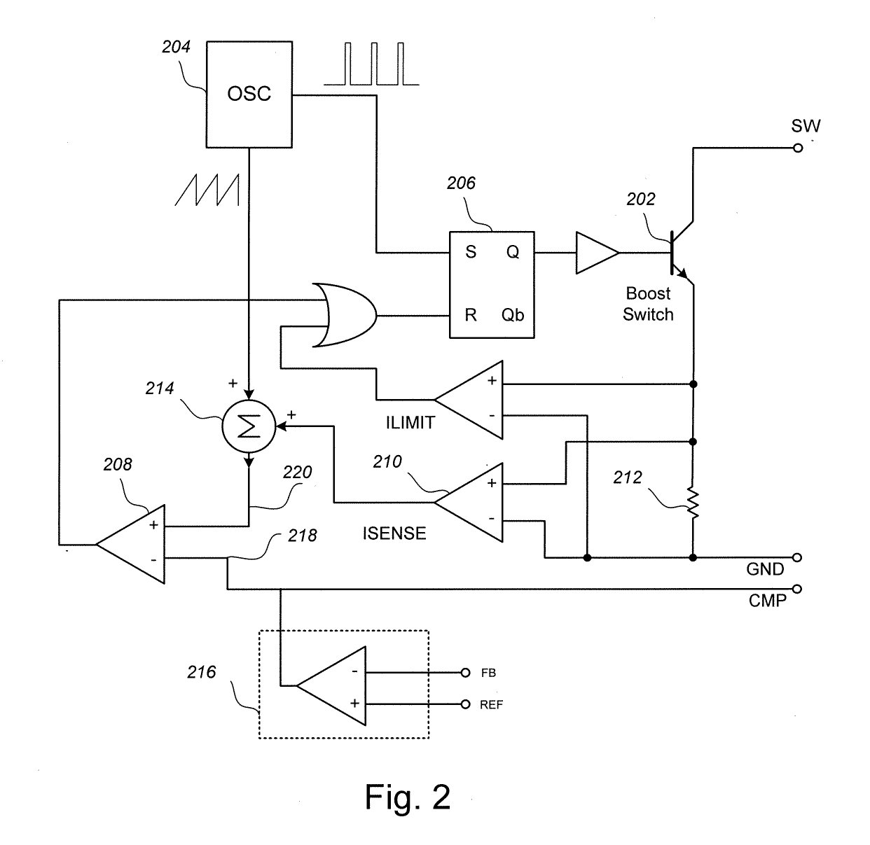

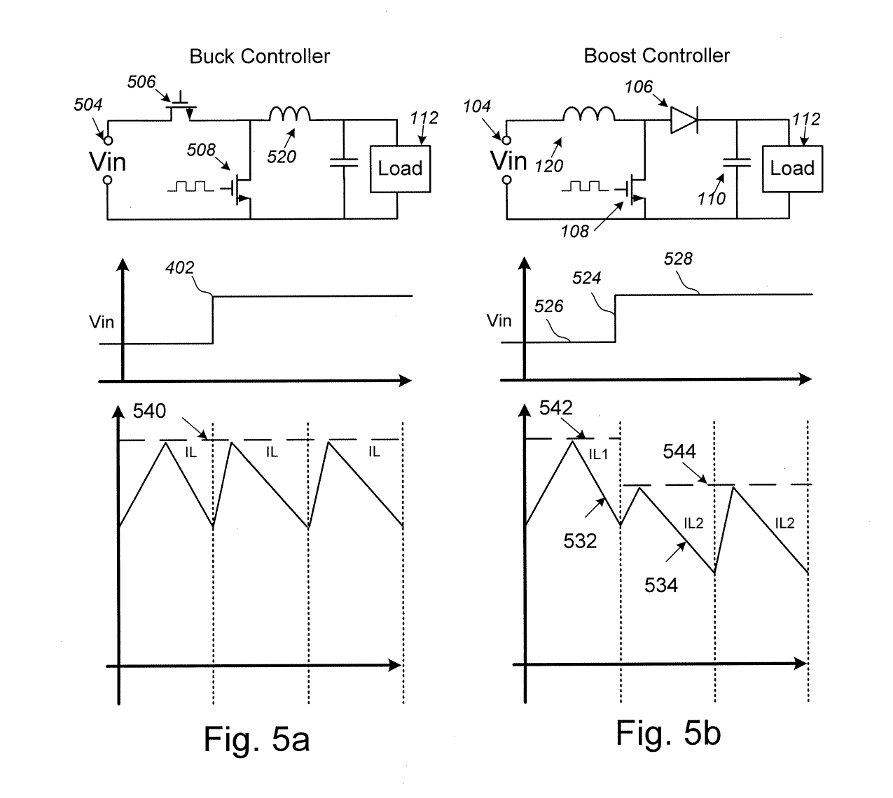

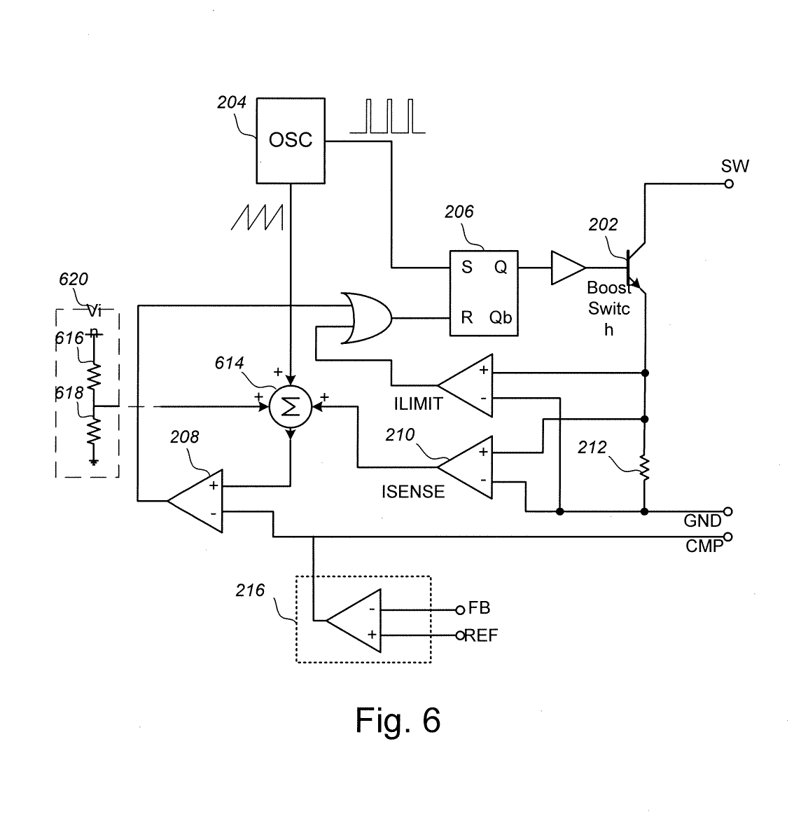

FIG. 6 is a block diagram of an embodiment of a power converter control circuit that includes the feed-forward component in accordance with the present invention. This block diagram differs from that shown in FIG. 2 in that an additional input port is added to the summing junction 214, shown as 614 in FIG. 5. The additional input is provided by the feed-forward circuit 620. In this embodiment, the feed-forward circuit comprises a voltage divider of the input voltage Vin comprising two resistors 616 and 618. Thus, a fraction of the input voltage is used to offset the trigger level of the comparator 208 that drives the set-reset flip flop 206 responsible for the PWM waveform. Therefore, when a voltage transient appears on the input, the trigger level of the comparator 208 is immediately shifted, and the PWM duty cycle quickly changes, moving the operating point close to its new equilibrium state without having to wait for the change to propagate through the loop filter.

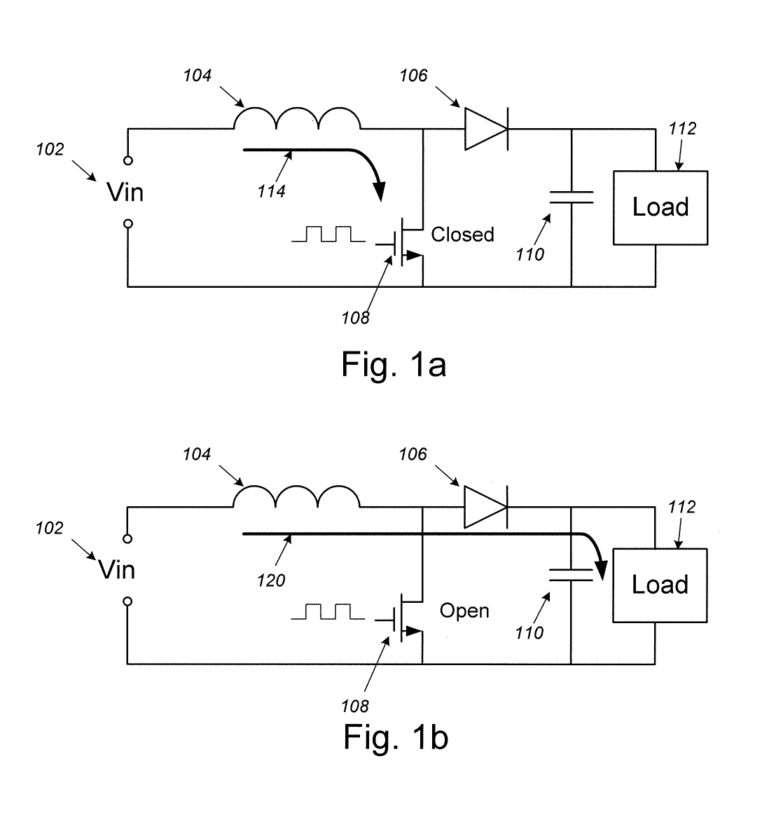

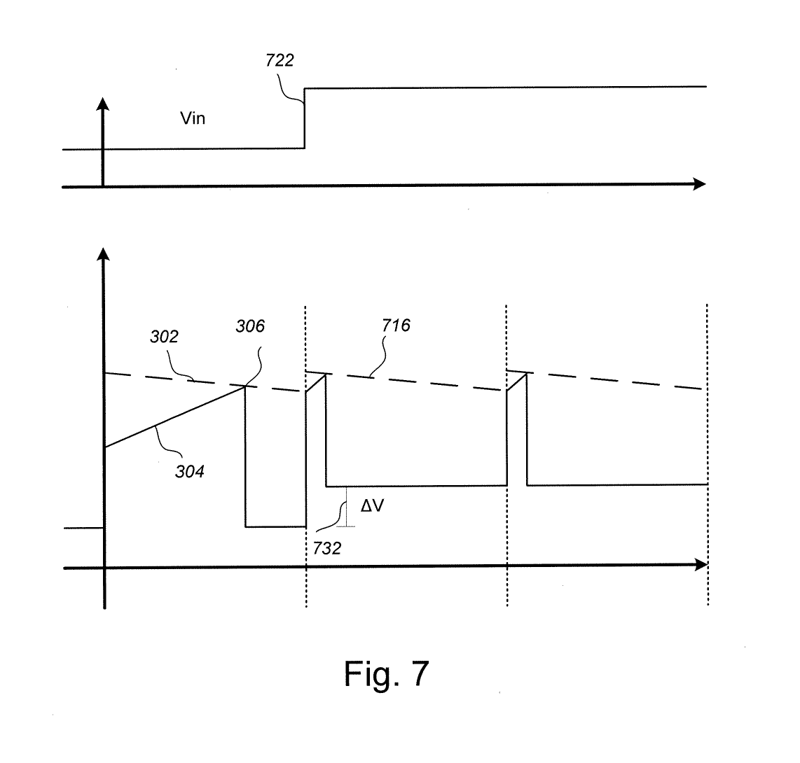

FIG. 7 is a waveform showing the improved transient behavior of the preferred embodiment. Trace 722 illustrates a voltage step at the input 102 (see FIG. 1a). The feed-forward circuit 620 (see FIG. 6) adds a fraction of this input voltage step to the summing junction, shifting up the waveform that drives comparator 208 (see FIG. 2). Voltage step 732 represents the voltage shift at the comparator 208 due to the feed-forward circuit. This shift of the waveform causes an earlier intersection point with the CMP waveform 302, shown at 716. This causes the PWM circuit to switch earlier, immediately dropping the duty cycle to a smaller value in order to pre-compensate for the shorter duty cycle that will eventually be set by the loop filter in response to the input transient. By selecting the resistors 616 and 618 in the feed-forward circuit 620 appropriately, the instantaneous change in the PWM duty cycle can be set such that it is close to where the equilibrium operating point will end up. This significantly reduces the settling time of the circuit.

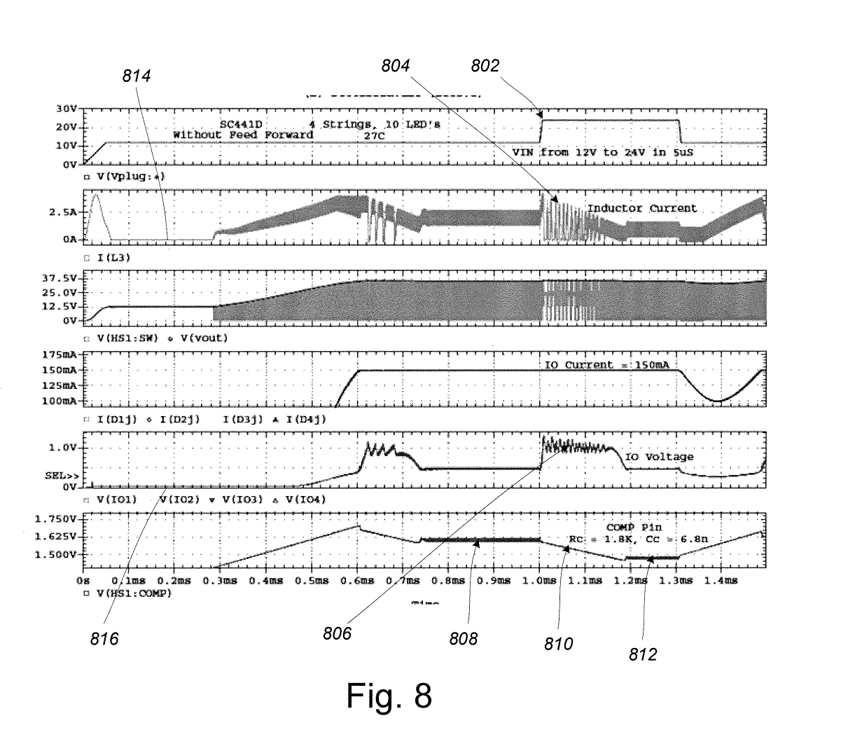

FIG. 8 is a circuit simulation illustrating the behavior of a switching power converter without the feed-forward circuit 620. The top trace simulates the input voltage to the converter. At knee 802, the input voltage jumps from 12 to 24 volts. For a period of approximately 0.2 ms after this step transient, the inductor current is unstable, as shown at 804. This instability in the inductor current is also reflected in the output voltage, as shown at 806. The bottom trace in FIG. 8 is the voltage at the compensation pin and explains the circuit behavior. Once the circuit is on and operating stably at an input voltage of 12 volts, the compensation pin reflects a steady set-point voltage 808. When the input voltage jumps from 12 to 24 volts, the PWM loop filter begins to respond by shortening the duty cycle, but it takes a few tenths of a millisecond for the loop filter to respond, as shown at 810, where the compensation voltage is slowly decreasing. Once the compensation voltage hits a new stable set point 812, the inductor current 814 (second trace from the top) and the output voltage 816 (second trace from the bottom) are again stable and well-behaved.

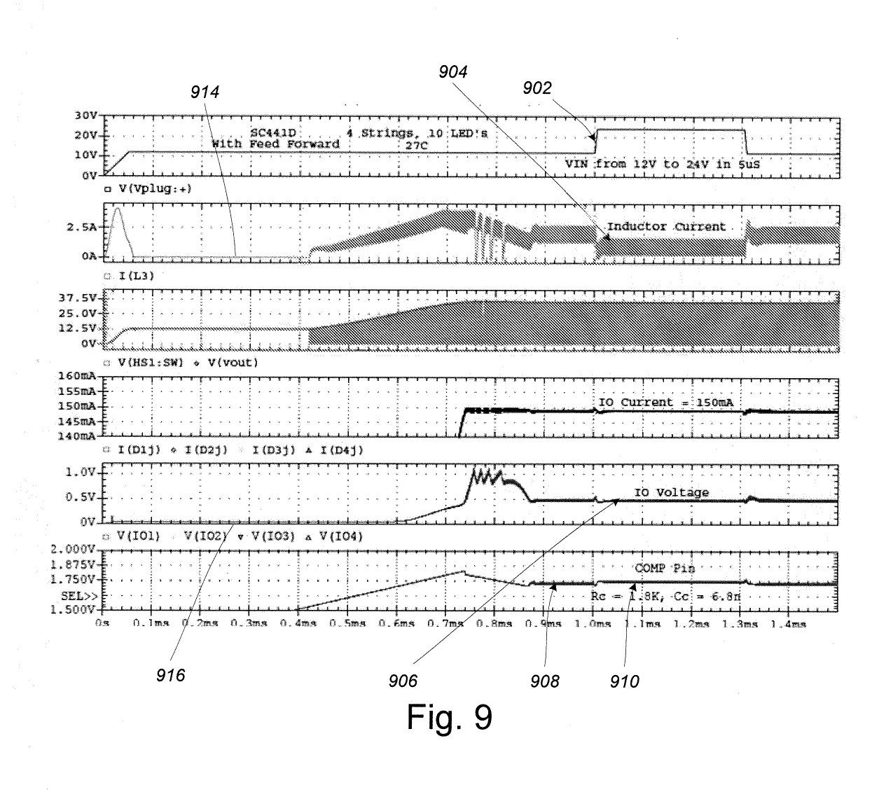

FIG. 9 is a circuit simulation illustrating the behavior of a switching power converter having a feed-forward circuit 620 in accordance with an embodiment of the present invention. Again, in this simulation, the input voltage is stepped from 12 to 24 volts, as shown at 902. However, in this case, with the feed-forward circuit providing a pre-bias to the comparator 208, the inductor current 914 is well behaved and exhibits only a short transient before settling stably at a new lower level 904. Likewise, the output voltage 916 exhibits only a short, small transient but stays nearly constant at its programmed set point, as shown at 906. The bottom trace shows how the compensation voltage tracks the input transient in this case. Just before the transient, the compensation voltage is constant at 908. When the input voltage jumps to 24 volts, a fraction of this step is used to offset the comparator trigger point, so the compensation voltage is already substantially at its new control point 910. This results in a very rapid response of the control loop because the PWM control loop essentially has only a very small error to track out since it was largely pre-compensated by the feed-forward circuit.

What is claimed is:

1. A boost-mode power converter exhibiting improved input transient response comprising:
an input voltage source;
a boost switch coupled to the input voltage source;
a Pulse Width Modulation (PWM) circuit coupled to the boost switch and configured to selectively open and close the boost switch;
a current sense circuit configured to provide a sense voltage indicative of a current flowing through the boost switch;
a ramp generator configured to generate a periodic voltage ramp;
a feed-forward circuit configured to generate a feed-forward voltage comprising a portion of the input voltage;
a summing junction configured to combine the sense voltage, the periodic voltage ramp, and the feed-forward voltage to create a feedback ramp voltage;
a comparison circuit configured to compare a voltage set point and the feedback ramp voltage and to trigger the PWM circuit when the feedback ramp voltage exceeds the voltage set point;

2. The boost-mode power converter of claim 1, wherein the feed-forward circuit comprises a resistive divider network.

3. The boost-mode power converter of claim 1, wherein the comparison circuit comprises a voltage comparator.

4. The boost-mode power converter of claim 1, further comprising a current limit circuit configured to measure a current flowing through the boost switch and to prevent the PWM circuit from switching the boost switch when the current flowing through the boost switch exceeds a preset threshold level.

5. The boost-mode power converter of claim 1, further comprising a slope compensation circuit configured to apply a voltage ramp to the voltage set point.

6. A boost-mode power converter exhibiting improved input transient response comprising:
an input voltage source;
a boost switch coupled to the input voltage source;
a Pulse Width Modulation (PWM) circuit coupled to the boost switch and configured to selectively open and close the boost switch;
a current sense circuit configured to provide a sense voltage indicative of a current flowing through the boost switch;
a ramp generator configured to generate a periodic voltage ramp;
a feed-forward circuit configured to generate a feed-forward voltage comprising a portion of the input voltage;
a summing junction configured to combine the sense voltage and the periodic voltage ramp to create a feedback ramp voltage;
a voltage set point combined with the feed-forward voltage to form a comparison voltage;
a comparison circuit configured to compare the comparison voltage and the feedback ramp voltage and to trigger the PWM circuit when the feedback ramp voltage exceeds the comparison voltage;

7. The boost-mode power converter of claim 6, wherein the feed-forward circuit comprises a resistive divider network.

8. The boost-mode power converter of claim 6, wherein the comparison circuit comprises a voltage comparator.

9. The boost-mode power converter of claim 6, further comprising a current limit circuit configured to measure a current flowing through the boost switch and to prevent the PWM circuit from switching the boost switch when the current flowing through the boost switch exceeds a preset threshold level.

10. The boost-mode power converter of claim 6, further comprising a slope compensation circuit configured to combine a voltage ramp with the voltage set point and the feed-forward voltage.

11. A boost-mode power converter exhibiting improved input transient response comprising:
an input voltage source;
a boost switch coupled to the input voltage source;
a Pulse Width Modulation (PWM) circuit coupled to the boost switch and configured to selectively open and close the boost switch;
a current sense circuit configured to provide a sense voltage indicative of a current flowing through the boost switch;
a ramp generator configured to generate a periodic voltage ramp;
a feed-forward circuit comprising a resistive divider network operatively coupled to the input voltage source and configured to produce an output reflective of the input voltage;
a summing junction configured to combine the sense voltage, the periodic voltage ramp, and the output of the feed-forward circuit to create a composite ramp voltage;
a comparison circuit configured to compare a voltage set point and the composite ramp voltage and to trigger the PWM circuit when the composite ramp voltage exceeds the voltage set point.

12. The boost-mode power converter of claim 11, wherein the comparison circuit comprises a voltage comparator.

13. The boost-mode power converter of claim 11, further comprising a current limit circuit configured to measure a current flowing through the boost switch and to prevent the PWM circuit from switching the boost switch when the current flowing through the boost switch exceeds a preset threshold level.

14. The boost-mode power converter of claim 11, further comprising a slope compensation circuit configured to apply a voltage ramp to the voltage set point.

15. In a boost-mode power convert comprising an input voltage source, a boost switch coupled to the input voltage source, a Pulse Width Modulation (PWM) circuit coupled to the boost switch and configured to selectively open and close the boost switch, a ramp generator configured to generate a periodic voltage ramp, a comparison circuit, and a feed-forward circuit; a method for improved transient response comprises the steps of:
generating a sense voltage indicative of a current flowing through the boost switch;
generating a periodic ramp voltage;
generating a feed-forward voltage indicative of the input voltage;
combining the ramp voltage, the sense voltage, and the feed-forward voltage to create a feedback ramp voltage;
generating a voltage set point;
comparing the voltage set point and the feedback ramp voltage;
generating a comparison trigger at a time when the feedback ramp voltage exceeds the voltage set point; and
triggering the PWM circuit with the comparison trigger.

16. The method of claim 15 further comprising the step of preventing the PWM circuit from switching the boost switch when a measured current flowing through the boost switch exceeds a preset threshold level.

17. The method of claim 15 further comprising the step of applying a voltage ramp to the voltage set point.

18. In a boost-mode power convert comprising an input voltage source, a boost switch coupled to the input voltage source, a Pulse Width Modulation (PWM) circuit coupled to the boost switch and configured to selectively open and close the boost switch, a ramp generator configured to generate a periodic voltage ramp, a comparison circuit, and a feed-forward circuit; a method for improved transient response comprises the steps of:
generating a sense voltage indicative of a current flowing through the boost switch;
generating a periodic ramp voltage;
generating a feed-forward voltage indicative of the input voltage;
combining the ramp voltage and the sense voltage to create a feedback ramp voltage;
generating a voltage set point;
combining the voltage set point with the feed-forward voltage to form a comparison voltage;
comparing the comparison voltage and the feedback ramp voltage;
generating a comparison trigger at a time when the feedback ramp voltage exceeds the comparison voltage; and
triggering the PWM circuit with the comparison trigger.

19. The method of claim 18 further comprising the step of preventing the PWM circuit from switching the boost switch when a measured current flowing through the boost switch exceeds a preset threshold level.

20. The method of claim 18 further comprising the step of applying a voltage ramp to the voltage set point.
